(19) United States
(12) Patent Application Publication
(10) Pub. No.: US 2026/0183662 A1
(43) Pub. Date: Jul. 2, 2026

(54) VIRTUAL CHARACTER PROCESSING METHOD AND APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Ziqi WEI, Shenzhen (CN)

(21) Appl. No.: 19/295,435

(22) Filed: Aug. 8, 2025

Related U.S. Application Data
(63) Continuation of application No. PCT/CN2024/095227, filed on May 24, 2024.

(30) Foreign Application Priority Data
Jul. 26, 2023 (CN) 202310934931.8

(51) Int. Cl. A63F 13/5372; A63F 13/2145; A63F 13/822; G06F 3/0486; G06F 3/0488

(52) U.S. Cl. CPC A63F 13/5372; A63F 13/2145; A63F 13/822; G06F 3/0486; G06F 3/0488

(57) ABSTRACT

This application provides a virtual character processing method performed by an electronic device. The method includes: displaying, in a battle interface, at least one preparation virtual character preparing to participate in a battle and a virtual character demonstration control associated with the at least one preparation virtual character; receiving, based on a user instruction via the virtual character demonstration control, demonstration instructions for a target virtual character in the at least one preparation virtual character; and demonstrating, in response to the demonstration instructions, a process in which the target virtual character performs interaction based on a target interaction attribute possessed by the target virtual character.

### CROSS-REFERENCE TO RELATED APPLICATIONS

This application is a continuation application of PCT Patent Application No. PCT/CN2024/095227, entitled “VIRTUAL CHARACTER PROCESSING METHOD AND APPARATUS, ELECTRONIC DEVICE, COMPUTER-READABLE STORAGE MEDIUM, AND COMPUTER PROGRAM PRODUCT” filed on May 24, 2024, which claims priority to Chinese Patent Application No. 2023109349318, entitled “VIRTUAL CHARACTER PROCESSING METHOD AND APPARATUS, ELECTRONIC DEVICE, COMPUTER-READABLE STORAGE MEDIUM, AND COMPUTER PROGRAM PRODUCT” filed on Jul. 26, 2023, both of which are incorporated herein by reference in their entirety.

### FIELD OF THE TECHNOLOGY

This application relates to the field of virtualization and man-machine interaction technologies, and in particular, to a virtual character processing method and apparatus, an electronic device, a computer-readable storage medium, and a computer program product.

### BACKGROUND OF THE DISCLOSURE

In a display technology based on graphics processing hardware, a channel for sensing an environment and obtaining information is expanded. Especially, in a multimedia technology in a virtual scene, with the help of a man-machine interaction engine technology, diversified interaction between virtual characters controlled by users or artificial intelligence can be implemented based on an actual application requirement. Various typical application scenes are provided. For example, in a virtual chess and card game scene (for example, a self-propelled chess game), an interaction process between virtual characters (generally, also referred to as virtual chess pieces) can be simulated.

In a scene in which a plurality of camps participate in a battle, before virtual characters are arranged in a camp, interaction conditions of the virtual characters usually need to be learnt. In the related art, a user can learn the interaction conditions of the virtual characters only by viewing related text guides of the virtual characters outside the battle (that is, in a non-battle scene), resulting in a poor information display effect. In addition, a plurality of times of man-machine interaction operations need to be performed during each time of viewing (for example, a control for viewing a character guide is first clicked, a to-be-viewed target virtual character is found from a large quantity of virtual characters through a plurality of operations such as swiping and filtering characters, and then the target virtual character is clicked for viewing), resulting in low man-machine interaction efficiency and a waste of processing resources of a device.

### SUMMARY

Embodiments of this application provide a virtual character processing method and apparatus, an electronic device, a computer-readable storage medium, and a computer program product, to optimize an information display effect and improve man-machine interaction efficiency.

Technical solutions in the embodiments of this application are implemented as follows:

An embodiment of this application provides a virtual character processing method performed by an electronic device, and the method including:
displaying, in a battle interface, at least one preparation virtual character preparing to participate in a battle and a virtual character demonstration control associated with the at least one preparation virtual character;
receiving, based on a user instruction via the virtual character demonstration control, demonstration instructions for a target virtual character in the at least one preparation virtual character; and
demonstrating, in response to the demonstration instructions, a process in which the target virtual character performs interaction based on a target interaction attribute possessed by the target virtual character.

An embodiment of this application further provides an electronic device, including:
a memory, configured to store computer-executable instructions; and
a processor, configured to implement, when executing the computer-executable instructions stored in the memory, the virtual character processing method provided in the embodiment of this application.

An embodiment of this application further provides a non-transitory computer-readable storage medium, having computer-executable instructions stored therein, the computer-executable instructions, when executed by a processor of an electronic device, causing the electronic device to implement the virtual character processing method provided in the embodiment of this application.

The embodiments of this application have the following beneficial effects.

When the embodiments of this application are applied, in a battle interface configured for virtual characters in a plurality of camps to have a battle in a virtual scene, at least one preparation virtual character preparing to participate in the battle is displayed, and a virtual character demonstration control is displayed. Based on the virtual character demonstration control, demonstration instructions for a target virtual character in the at least one preparation virtual character are received. In response to the demonstration instructions, a process in which the target virtual character performs interaction based on a target interaction attribute possessed by the target virtual character is demonstrated.

One virtual character demonstration control is provided in the battle interface, and demonstration instructions for the virtual characters can be triggered through the virtual character demonstration control, to demonstrate a process in which the virtual characters perform interaction based on target interaction attributes possessed by the virtual characters. In this way, first, a user can learn an interaction attribute of the virtual character and a corresponding interaction condition more comprehensively and intuitively, an information display effect is optimized, and display resource utilization is improved; and second, a quantity of times of man-machine interaction operations that are to be performed to achieve an objective (that is, learn the interaction attribute of the virtual character and the corresponding interaction condition) is reduced, and man-machine interaction efficiency and device resource utilization are improved.

### BRIEF DESCRIPTION OF THE DRAWINGS

FIG. 1 is a schematic architectural diagram of a virtual character processing system according to an embodiment of this application.

FIG. 2 is a schematic structural diagram of an electronic device 500 for implementing a virtual character processing method according to an embodiment of this application.

FIG. 3 is a schematic flowchart of a virtual character processing method according to an embodiment of this application.

FIG. 4A is a schematic diagram of displaying a battle interface according to an embodiment of this application.

FIG. 4B is a schematic diagram of displaying a battle interface according to an embodiment of this application.

FIG. 5 is a schematic diagram of displaying a battle interface according to an embodiment of this application.

FIG. 6 is a schematic flowchart of triggering demonstration instructions according to an embodiment of this application.

FIG. 7 is a schematic flowchart of exiting a demonstration according to an embodiment of this application.

FIG. 8 is a schematic diagram of displaying a demonstration battle interface according to an embodiment of this application.

FIG. 9 is a schematic diagram of displaying a demonstration battle interface according to an embodiment of this application.

FIG. 10 is a schematic diagram of displaying a demonstration battle interface according to an embodiment of this application.

FIG. 11 is a schematic diagram of displaying a demonstration battle interface according to an embodiment of this application.

FIG. 12 is a schematic diagram of displaying a demonstration battle interface according to an embodiment of this application.

FIG. 13 is a schematic flowchart of a virtual character processing method according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts fall within the protection scope of this application.

In the following descriptions, a term “some embodiments” involved describes subsets of all possible embodiments, but “some embodiments” may be the same subset or different subsets of all the possible embodiments, and may be combined with each other without conflict.

In the following descriptions, the terms “first”, “second”, and “third” are merely intended to distinguish similar objects but do not indicate a specific order of objects. The specific order or sequence of “first”, “second”, and “third” may be interchangeable in proper circumstances to enable the embodiments of this application to be implemented in other orders than those illustrated or described herein.

Unless otherwise defined, meanings of all technical and scientific terms used in the embodiments of this application are the same as those usually understood by a person skilled in the art. Terms used in the embodiments of this application are merely intended to describe objectives of the embodiments of this application, but are not intended to limit this application.

In the embodiments of this application, the term “module” or “unit” refers to a computer program with a preset function or a part of the computer program and works, together with other related parts, to implement a preset target, and may be completely or partially implemented by using software, hardware (such as a processing circuit or a memory) or a combination thereof. Similarly, one processor (or a plurality of processors or memories) may be configured to implement one or more modules or units. In addition, each module or unit may be a part of an overall module or unit including a function of the module or the unit.

Before the embodiments of this application are further described in detail, descriptions are made on nouns and terms in the embodiments of this application, and the nouns and terms in the embodiments of this application are applicable to the following explanations.
(1) Client: It is an application program that runs in a terminal and is used for providing various services, for example, a client that supports a virtual chess and card game.
(2) In response to: It is configured for representing a condition or state on which a performed operation depends. When the dependent condition or state is satisfied, one or more operations performed may be in real time or may have a set delay. Unless otherwise specified, there is no limitation on an order in which a plurality of operations are performed.
(3) Virtual scene: It is a virtual scene displayed (or provided) when an application program runs on a terminal. The virtual scene may be a simulated environment for the real world, or may be a semi-simulated and semi-fictional virtual environment, or may be an entirely fictional virtual environment. The virtual scene may be any one of a two-dimensional virtual scene, a 2.5-dimensional virtual scene, or a three-dimensional virtual scene.
(4) Self-propelled chess game: It is a game manner in which virtual chess pieces are placed for a battle, and is a general term of electronic strategy chess and card games. A basic game rule thereof is that a player matches a virtual chess piece lineup and arranges the virtual chess piece lineup on a virtual chessboard of the player, to fight against a virtual chess piece lineup of an opponent. During a battle, virtual chess pieces of players automatically fight against each other, and a victory is obtained by defeating an opposite party.
(5) Virtual chessboard: It is a virtual chessboard displayed (or provided) when an application program runs on a terminal. The virtual chessboard may be a simulated chessboard of a real chessboard, or may be a semi-simulated and semi-fictional chessboard, or may be an entirely fictional chessboard. The virtual chessboard may be any one of a two-dimensional virtual chessboard, a 2.5-dimensional virtual chessboard, or a three-dimensional virtual chessboard. This is not limited in the embodiments of this application.

In an example, the virtual chessboard includes areas for preparing and performing a battle. The virtual chessboard is divided into a battle area and a preparation area. The battle area includes several battle chess grids having the same size, and the battle chess grids are configured for placing battle virtual characters that participate in the battle during the battle. The preparation area includes several preparation chess grids. The preparation chess grids are configured for placing preparation virtual characters preparing for the battle. During the battle, the preparation virtual characters do not participate in the battle. However, the preparation virtual characters may be dragged to be placed in the battle area in a preparation stage, and are activated to be in a battle state, to become the battle virtual characters.

In the embodiments of this application, the virtual chessboard further includes a demonstration area. In an example, after a player drags a target virtual character into the demonstration area, the demonstration area is activated to enter a demonstration mode. In the demonstration mode, various real battle demonstrations of the target virtual character including effects such as skills, attacks, bonds, and equipment may be viewed, so that the player may quickly view and learn information about the virtual character in a battle stage or the preparation stage, to make more accurate layout determining.
(6) Virtual character: For example, in a virtual chess and card game, a virtual chess piece can represent a virtual character. The virtual character specifically refers to a movable object participating in a battle. The movable object may be a virtual character, a virtual animal, an anime character, and the like. In the self-propelled chess game, virtual characters include a battle virtual character and a preparation virtual character. The battle virtual character is a virtual character located in the battle area, and the preparation virtual character is a virtual character located in the preparation area. In some embodiments, the virtual character is a three-dimensional model created based on a skeletal animation technology, and the virtual character may be presented by using the three-dimensional model. Each virtual character has its own shape and volume in the virtual chessboard, and occupies some space in the virtual chessboard.

Each virtual character has its unique skill mechanism and battle mechanism, and a plurality of virtual characters with similar bonds can further activate a strong bond effect. A series of factors such as an attribute (quality and a star level), a virtual skill, a bond bonus, and virtual equipment of the virtual character determine battle power of the virtual character. In an example, in the self-propelled chess game, higher battle power of a virtual chess piece lineup indicates higher battle strength. The battle strength determines a victory or a defeat of the battle.

The virtual equipment has an equipment attribute, and the equipment attribute is used to improve a battle attribute of the virtual character. The virtual equipment includes attack equipment, defense equipment, functional equipment, and the like. The attack equipment includes various forms of knifes, swords, bows and arrows, spears, daggers, guns, and the like, can improve attack force, an attack speed, an attack range, a critical hit probability, and the like of the virtual character, and can further provide an attack skill for the virtual character. The defense equipment includes various forms of shields, armors, protectors, protective covers, and the like, can improve defense power, a health point, a health point restoration speed, and the like of the virtual character, and can provide a defense skill for the virtual character. The functional equipment includes various forms of accessories, shoes, gemstones, and the like, can have a capability of improving an effect for an attribute such as a movement speed of the virtual character, and can add a functional skill to the virtual character. For example, the player triggers the functional skill to restore the health point, improve the movement speed, and increase a speed of accumulating virtual gold coins for the virtual character. Generally, at least two pieces of virtual equipment at the same equipment level may be synthesized into a piece of virtual equipment at a higher level, to improve an effect of increasing the battle attribute of the virtual character. For example, two pieces of virtual equipment at basic levels may be synthesized into a piece of advanced virtual equipment.
(7) Bond (namely, a bond attribute): It is a special relationship between virtual characters, which can enable capabilities of the virtual characters to play a larger role, and enhance battle power of the virtual characters. In an example, each virtual character has at least one type of bond. Activating a bond may provide additional battle power for the virtual character. To activate a bond, at least two virtual characters that have the bond need to synchronously join a battle.

The embodiments of this application provide a virtual character processing method and apparatus, an electronic device, a computer-readable storage medium, and a computer program product. In this way, first, a user can learn an interaction condition of a virtual character more comprehensively and intuitively, an information display effect is optimized, and display resource utilization is improved; second, the user can learn an interaction condition of a preparation virtual character in a process in which the virtual character participates in a battle, a layout effect of a battle lineup is improved, and immersive experience of a virtual scene is optimized; and third, a quantity of times of man-machine interaction operations that are to be performed to achieve an objective (that is, learn the interaction condition of the virtual character) is reduced, and man-machine interaction efficiency and device resource utilization are improved. Next, descriptions are respectively provided.

During example application of related data collection and processing in this application, the informed consent or individual consent of a personal information subject needs to be obtained in strict accordance with the requirements of related laws and regulations, and the subsequent data use and processing behavior is carried out within the scope of authorization of laws and regulations and the personal information subject.

To facilitate easier understanding of the virtual character processing method provided in the embodiments of this application, the following describes an exemplary implementation scenario of the virtual character processing method provided in the embodiments of this application. The virtual character processing method provided in the embodiments of this application may be implemented by various electronic devices, for example, may be implemented by a terminal alone, or may be implemented by a server alone, or may be collaboratively implemented by a terminal and a server.

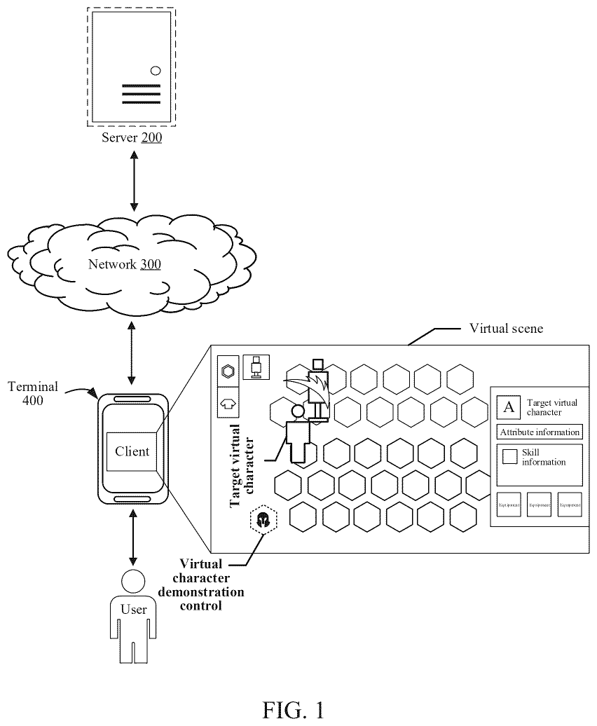

In some embodiments, the virtual scene in the embodiments of this application may be output completely based on a terminal, or may be output based on collaboration between a terminal and a server. An example in which the virtual scene is output based on the collaboration between the terminal and the server is used to describe the virtual character processing system provided in the embodiments of this application. FIG. 1 is a schematic architectural diagram of a virtual character processing system according to an embodiment of this application. To support an exemplary application, a terminal 400 is connected to a server 200 through a network 300. The network 300 may be a wide area network, a local area network, or a combination thereof. Data transmission is implemented through a wireless link or a wired link.

The terminal 400 (on which a client runs) is configured to receive, based on a view interface, a trigger operation for entering a virtual scene, and send an obtaining request for scene data of the virtual scene to the server 200. The server 200 is configured to receive the obtaining request for the scene data, and return, in response to the obtaining request, the scene data of the virtual scene to the terminal. The terminal 400 is further configured to receive the scene data of the virtual scene, perform rendering based on the scene data of the virtual scene, and output the virtual scene. The virtual scene is an environment provided for interaction between virtual characters, for example, may be a virtual chessboard provided for the virtual characters to have a battle. After outputting the virtual scene, the terminal 400 displays a battle interface configured for virtual characters in a plurality of camps to have a battle in the virtual scene, displays, in the battle interface, at least one preparation virtual character preparing to participate in the battle, and displays a virtual character demonstration control; receives, based on the virtual character demonstration control, demonstration instructions for a target virtual character in the at least one preparation virtual character; and demonstrates, in response to the demonstration instructions, a process in which the target virtual character performs interaction based on a target interaction attribute possessed by the target virtual character.

In some embodiments, a server (for example, the server 200) may be an independent physical server, or may be a server cluster or a distributed system including a plurality of physical servers. A terminal (for example, the terminal 400-1) may be a notebook computer, a tablet computer, a desktop computer, a smartphone, a smart voice interaction device (for example, a smart speaker), a smart home appliance (for example, a smart television), a smart watch, a vehicle-mounted terminal, a wearable device, a virtual reality (VR) device, or the like, but is not limited thereto. The terminal and the server may be connected directly or indirectly in a wired or wireless communication manner. This is not limited in the embodiments of this application.

In some embodiments, the virtual character processing method provided in the embodiments of this application may be implemented with the help of a cloud technology. The cloud technology refers to a hosting technology that unifies a series of resources such as hardware, software, and networks in a wide area network or a local area network to implement computing, storage, processing, and sharing of data. The cloud technology is a collective name of a network technology, an information technology, an integration technology, a platform management technology, an application technology, and the like based on application of a cloud computing business mode. The technologies may form a resource pool for use on demand, which is flexible and convenient. A cloud computing technology will become an important support. Backend services of a technological network system require a lot of computing and storage resources. In an example, the server (for example, the server 200) may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform.

In some embodiments, the terminal or the server may implement the virtual character processing method provided in the embodiments of this application by running various computer-executable instructions or computer programs. For example, the computer-executable instructions may be a microprogram-level command, machine instructions, or software instructions. The computer program may be an original program or a software module in an operating system, may be a native application (APP) program, which can only be run after being installed in the operating system, for example, a virtual chess and card game APP, or may be a mini program that can be embedded into any APP, i.e. a program that only needs to be downloaded into a browser environment to run. In conclusion, the foregoing computer-executable instructions may be instructions in any form, and the foregoing computer program may be an application program, a module, or a plug-in in any form.

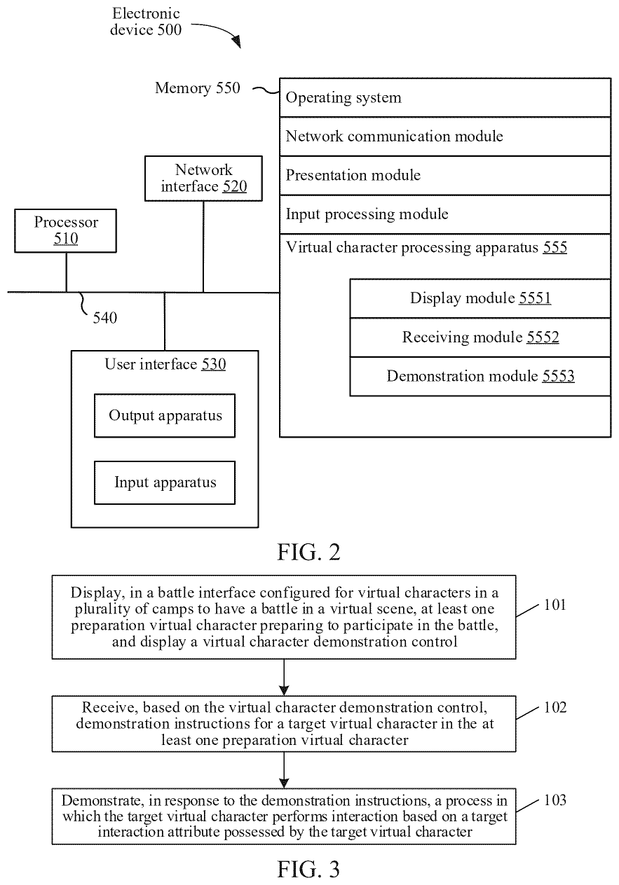

The following describes an electronic device for implementing the virtual character processing method provided in the embodiments of this application. FIG. 2 is a schematic structural diagram of an electronic device 500 for implementing a virtual character processing method according to an embodiment of this application. The electronic device 500 provided in this embodiment of this application may be a terminal or a server. The electronic device 500 provided in this embodiment of this application includes: at least one processor 510, a memory 550, at least one network interface 520, and a user interface 530. Various components in the electronic device 500 are coupled together through a bus system 540. The bus system 540 is configured for implementing connection and communication between the components. In addition to a data bus, the bus system 540 also includes a power bus, a control bus, and a state signal bus. However, for clarity of description, all types of buses in FIG. 2 are marked as the bus system 540.

In some embodiments, the virtual character processing apparatus provided in the embodiments of this application may be implemented by software. FIG. 2 shows a virtual character processing apparatus 555 stored in the memory 550, which may be software in a form of a program, a plug-in, and the like, and includes the following software modules: a display module 5551, a receiving module 5552, and a demonstration module 5553. These modules are logical and therefore can be combined or further divided according to functions to be implemented. Functions of the modules will be described below.

The following describes the virtual character processing method provided in the embodiments of application. In some embodiments, the virtual character processing method provided in the embodiments of this application may be implemented by various electronic devices, for example, may be implemented by a terminal alone, or may be implemented by a server alone, or may be collaboratively implemented by a terminal and a server. An example in which the virtual character processing method provided in the embodiments of this application is implemented by a terminal is used. FIG. 3 is a schematic flowchart of a virtual character processing method according to an embodiment of this application. The virtual character processing method provided in this embodiment of this application includes:

Operation 101: The terminal displays, in a battle interface configured for virtual characters in a plurality of camps to have a battle in a virtual scene, at least one preparation virtual character preparing to participate in the battle, and displays a virtual character demonstration control.

A client (for example, a game client) that supports the virtual scene may run on the terminal, and the terminal outputs the virtual scene (for example, a virtual chess and card game scene) in a running process of the client. For example, the terminal may obtain scene data of the virtual scene from a server, and then perform rendering on the scene data, to output the virtual scene. A plurality of camps that confront each other are included in the virtual scene, each camps includes at least one virtual character, and virtual characters in different camps may battle against each other. Therefore, the terminal displays the battle interface configured for the virtual characters in the plurality of camps to have a battle in the virtual scene.

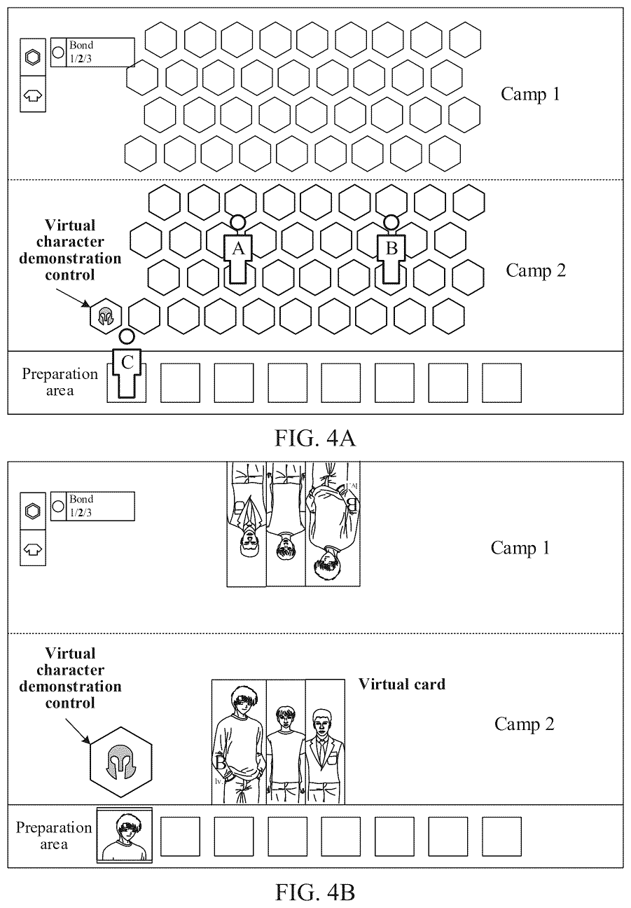

In an example, FIG. 4A is a schematic diagram of displaying a battle interface according to an embodiment of this application. The virtual scene is a self-propelled chess game scene. The battle interface is a virtual chessboard, including two camps. Each camp includes a plurality of virtual characters (for example, virtual chess pieces A and B) arranged on the virtual chessboard, and virtual chess pieces in different camps may be used for a battle. In an example, FIG. 4B is a schematic diagram of displaying a battle interface according to an embodiment of this application. The virtual scene is a card game scene. Two camps are displayed in the battle interface. Each camp includes a plurality of virtual characters (namely, virtual cards), and virtual cards in different camps may be used for a battle.

In this embodiment of this application, virtual characters in a camp include a battle virtual character and a preparation virtual character. The battle virtual character is a virtual character (located in a battle area of the battle interface) participating in a battle during the battle, and the preparation virtual character is a virtual character (located in a preparation area of the battle interface) preparing to participate in the battle. When arranging a lineup of a camp, a player arranges the preparation virtual character in the battle area of the battle interface according to requirements, to enable the preparation virtual character to become the battle virtual character. When arranging the lineup of the camp, the player usually needs to learn an interaction condition (including an interaction attribute and an interaction process based on the interaction attribute) of the preparation virtual character. For example, the interaction condition includes, but is not limited to, an interaction effect of a target virtual character in an interaction battle based on a virtual skill, a virtual attack, a virtual bond, virtual equipment, and the like.

Therefore, in this embodiment of this application, still referring to FIG. 4A and FIG. 4B, one virtual character demonstration control is provided in the battle interface. As shown in FIG. 4A, demonstration instructions may be triggered by a trigger operation for the virtual character demonstration control. As shown in FIG. 4B, the demonstration instructions may be triggered by moving the target virtual character to an area associated with the virtual character demonstration control. Demonstration instructions for a specific preparation virtual character can be triggered through the virtual character demonstration control, to demonstrate a process in which the specific preparation virtual character performs interaction based on an interaction attribute possessed by the specific preparation virtual character. In this way, a user can learn the interaction attribute of the specific preparation virtual character and a corresponding interaction condition more comprehensively and intuitively in a process in which the virtual character participates in a battle. This helps achieve a better display effect of related information of the specific preparation virtual character, improve display resource utilization and information reachability, improve a layout effect and layout efficiency of a battle lineup, and enhance immersive experience of the user in a virtual scene.

Operation 102: Receive, based on the virtual character demonstration control, demonstration instructions for the target virtual character in the at least one preparation virtual character.

The user may designate, based on the virtual character demonstration control in the battle interface, the target virtual character in the at least one preparation virtual character for demonstration. Based on this, a terminal receives, based on the virtual character demonstration control, the demonstration instructions for the target virtual character in the at least one preparation virtual character.

In some embodiments, the terminal may receive, based on the virtual character demonstration control, the demonstration instructions for the target virtual character in the at least one preparation virtual character in the following manner: displaying, in response to a trigger operation for the virtual character demonstration control, a selection control of each preparation virtual character; and receiving, in response to a selection operation that is triggered based on the selection control and that is for the target virtual character, the demonstration instructions for the target virtual character in the at least one preparation virtual character.

When receiving the trigger operation for the virtual character demonstration control, the terminal may provide a corresponding selection control for each preparation virtual character, that is, display a selection control of each preparation virtual character. The user may select a corresponding preparation virtual character through the selection control. When receiving the selection operation that is triggered based on the selection control and that is for the target virtual character, the terminal receives, in response to the selection operation, the demonstration instructions for the target virtual character in the at least one preparation virtual character. In this way, only one virtual character demonstration control may be provided for the at least one preparation virtual character, to optimize a display effect of the control, and improve display resource utilization.

The trigger operation in this embodiment of this application includes, but is not limited to, an operation such as clicking, double-clicking, touching-and-holding, and swiping. The control in this embodiment of this application may be equivalent to a function item, and may have a plurality of display forms, such as a graphic button, a progress bar, a menu, and a list. This is not limited in this embodiment of this application. The user or player mentioned in this embodiment of this application may be an object corresponding to an account currently logged in to a client, or may be an object who uses a current client when the client is currently in a logged-out state.

In some embodiments, the terminal may display the virtual character demonstration control in the following manner: displaying a virtual character demonstration control of each preparation virtual character. Correspondingly, the terminal may receive, based on the virtual character demonstration control and in the following manner, the demonstration instructions for the target virtual character in the at least one preparation virtual character: receiving, in response to a trigger operation for a virtual character demonstration control of the target virtual character, the demonstration instructions for the target virtual character in the at least one preparation virtual character.

The terminal provides a corresponding virtual character demonstration control for each preparation virtual character, that is, the terminal displays a virtual character demonstration control of each preparation virtual character. In this way, the user can demonstrate a preparation virtual character that needs to be demonstrated through a corresponding virtual character demonstration control. When receiving the trigger operation for the virtual character demonstration control of the target virtual character, the terminal receives, in response to the trigger operation, the demonstration instructions for the target virtual character in the at least one preparation virtual character. In this way, the demonstration instructions for the target virtual character may be triggered only by triggering the trigger operation for the virtual character demonstration control of the target virtual character. As a result, man-machine interaction operations that are to be performed to achieve an interaction objective is reduced, and man-machine interaction efficiency and device resource utilization are improved.

In some embodiments, the battle interface includes a preparation area (namely, a preparation area) and a battle area (namely, a battle area). The terminal may display, in the following manner, the at least one preparation virtual character preparing to participate in a battle: displaying, in the preparation area, the at least one preparation virtual character preparing to participate in the battle. Correspondingly, the terminal may display the virtual character demonstration control in the following manner: displaying, in the battle area, the virtual character demonstration control.

The battle interface includes the preparation area and the battle area. The preparation area is configured for placing a preparation virtual character preparing to participate in a battle during the battle, and the battle area is configured for placing a virtual character participating in the battle during the battle. In this way, at least one preparation virtual character preparing to participate in the battle may be displayed in the preparation area, and the virtual character demonstration control may be displayed in the battle area. In this way, proper planning of display resources is implemented, the preparation area and the battle area are separately set, and respective information is displayed in different areas, so that viewing experience of a user is better, and display resource utilization is improved.

In some embodiments, the battle interface is a virtual chessboard, and the battle area includes a plurality of battle chess grids. The terminal may display, in the battle area and in the following manner, the virtual character demonstration control: displaying, in the battle area, a demonstration battle chess grid different from the battle chess grid, the demonstration battle chess grid indicating the virtual character demonstration control. Correspondingly, the terminal may receive, based on the virtual character demonstration control and in the following manner, the demonstration instructions for the target virtual character in the at least one preparation virtual character: receiving a first dragging operation of dragging the target virtual character from the preparation area to the demonstration battle chess grid; and receiving, in response to the first dragging operation being released, the demonstration instructions for the target virtual character in the at least one preparation virtual character.

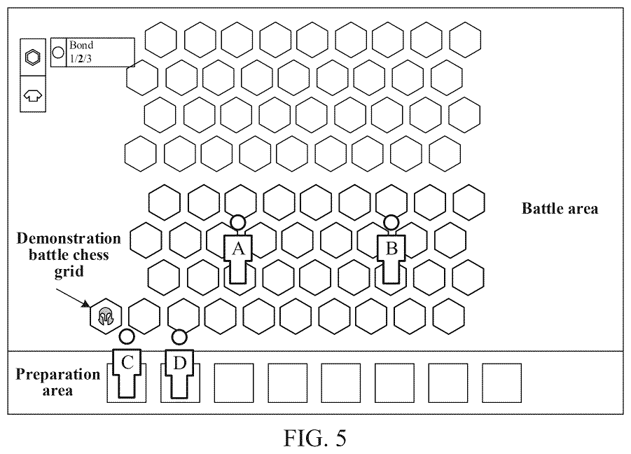

The battle interface may be a virtual chessboard, and the virtual chessboard is also divided into a battle area and a preparation area. The battle area includes a plurality of battle chess grids, each battle chess grid is a sub-battle area in the battle area, and each battle chess grid is configured for placing a battle virtual character. The preparation area is configured for placing a preparation virtual character. The preparation area may also include at least one sub-preparation area, and each sub-preparation area is configured for placing a preparation virtual character. In this embodiment of this application, a demonstration battle chess grid is further provided in the battle area, and the demonstration battle chess grid is the foregoing virtual character demonstration control. As shown in FIG. 5, the virtual chessboard includes the battle area and the preparation area. A battle virtual character A and a battle virtual character B are placed in the battle area, and a preparation virtual character C and a preparation virtual character D are placed in the preparation area. In addition, one demonstration battle chess grid (namely, a virtual character demonstration control) is displayed in the battle area.

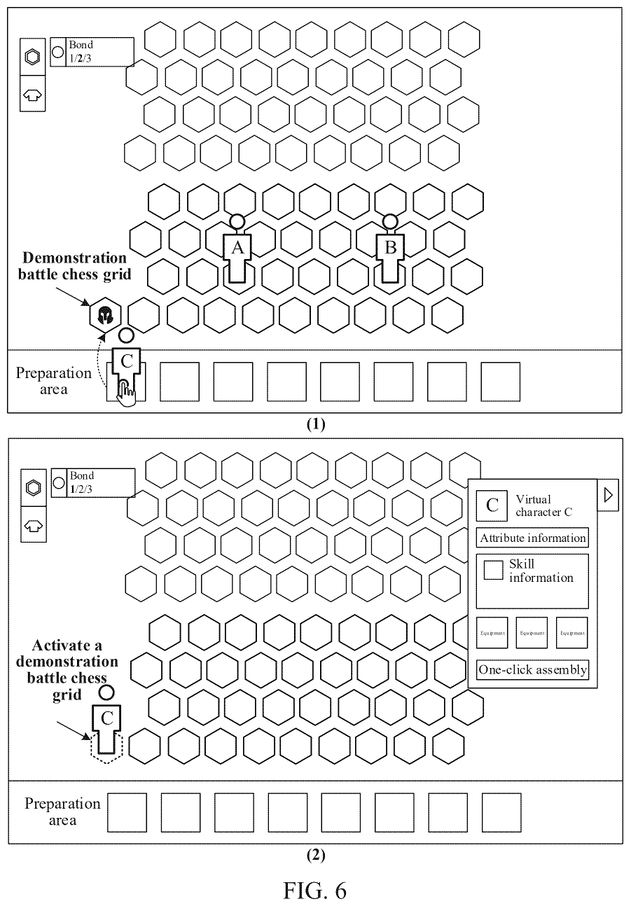

Based on this, the demonstration instructions for the target virtual character may be triggered by dragging the target virtual character from the preparation area to the demonstration battle chess grid. When the terminal receives the first dragging operation of dragging the target virtual character from the preparation area to the demonstration battle chess grid, if the first dragging operation is released, the terminal receives the demonstration instructions for the target virtual character. For example, referring to FIG. 6, as shown in (1) in FIG. 6, the terminal receives the first dragging operation of dragging the target virtual character (namely, a preparation virtual character C) from the preparation area to the demonstration battle chess grid, and receives, when the first dragging operation is released, the demonstration instructions for the target virtual character.

When the foregoing embodiment is applied, the target virtual character in the preparation area is dragged to the demonstration battle chess grid in the battle area and the dragging operation is released, so that the demonstration instructions for the target virtual character may be triggered. A man-machine interaction operation is simple, man-machine interaction efficiency for achieving an interaction objective (triggering the demonstration instructions for the target virtual character) is improved, a waste of device resources is reduced, and device resource utilization is improved.

In some embodiments, the terminal may exit demonstration for the target virtual character in the following manner: receiving a second dragging operation of dragging the target virtual character from the demonstration battle chess grid to the preparation area; and exiting, in response to the second dragging operation being released, the demonstration for the target virtual character.

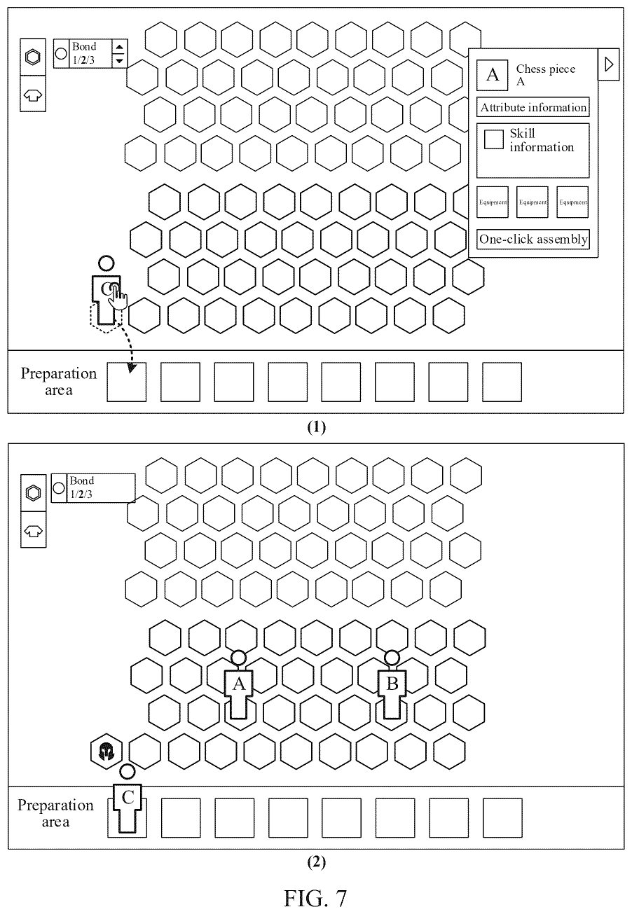

Referring to FIG. 7, the target virtual character may be dragged from the demonstration battle chess grid back to the preparation area, to trigger demonstration exit instructions for the target virtual character. As shown in (1) in FIG. 7, the terminal receives the second dragging operation of dragging the target virtual character from the demonstration battle chess grid to the preparation area. When the second dragging operation is released, the terminal exits, in response to the second dragging operation being released, demonstration for the target virtual character. In this way, the target virtual character is dragged from the demonstration battle chess grid to the preparation area and the dragging operation is released, so that exit of the demonstration may be controlled. A man-machine interaction operation is simple, man-machine interaction efficiency for achieving an interaction objective (controlling a process of exiting the demonstration) is improved, a waste of device resources is reduced, and device resource utilization is improved.

Operation 103: Demonstrate, in response to the demonstration instructions, a process in which the target virtual character performs interaction based on a target interaction attribute possessed by the target virtual character.

After receiving the demonstration instructions for the target virtual character, the terminal demonstrates, in response to the demonstration instructions, the process in which the target virtual character performs interaction based on the target interaction attribute possessed by the target virtual character. In this way, an interaction condition of the target virtual character can be demonstrated to a user. The interaction condition includes, but is not limited to, an interaction effect (including, but not limited to, an effect of a virtual skill, an effect of virtual equipment, an attack effect of a virtual attack, and a battle power bonus effect of a virtual bond) of the target virtual character in an interaction battle based on the virtual skill, the virtual attack, the virtual bond, the virtual equipment, and the like. The demonstrated process in which the target virtual character performs interaction based on the target interaction attribute possessed by the target virtual character can present, to the user, the interaction effect of the target virtual character in the interaction battle based on the virtual skill, the virtual attack, the virtual bond, the virtual equipment, and the like. In this way, the user can learn an interaction attribute of the preparation virtual character and a corresponding interaction condition more comprehensively and intuitively in a process in which the virtual character participates in a battle.

When the process in which the target virtual character performs interaction based on the target interaction attribute possessed by the target virtual character is demonstrated, a process in which the target virtual character interacts with a demonstration virtual character based on the target interaction attribute possessed by the target virtual character may be demonstrated. The demonstration virtual character may be any virtual character supported in a virtual scene. In this way, a demonstration effect in an interaction process is increased, and it is convenient for a user to learn the interaction condition of the target virtual character.

The target interaction attribute includes, but is not limited to, a character attribute (for example, a star level and quality), a virtual skill attribute, a virtual bond attribute, and a virtual equipment attribute of the virtual character. The virtual skill attribute is configured for indicating an attribute (for example, attack force of an attack skill or healing power of a healing skill) of a virtual skill possessed by the target virtual character. The virtual bond attribute is configured for indicating an attribute of a bond possessed by the target virtual character, for example, a battle power bonus value that can be provided for the virtual character by activating the bond. The virtual equipment skill is configured for indicating an attribute (for example, attack force of attack equipment and defense power of defense equipment) of virtual equipment assembled by the target virtual character.

There may be one or more target virtual characters. The user may make a selection according to requirements.

In some embodiments, the terminal may demonstrate, in the following manner, the process in which the target virtual character performs interaction based on the target interaction attribute possessed by the target virtual character: switching, in response to the demonstration instructions, from displaying a battle interface to displaying a demonstration battle interface of the target virtual character; and demonstrating, through the demonstration battle interface, the process in which the target virtual character performs interaction based on the target interaction attribute.

As shown in (2) in FIG. 6, after receiving the demonstration instructions, the terminal switches the battle interface to the demonstration battle interface of the target virtual character, that is, cancels displaying of an original battle virtual character in the battle interface, to demonstrate, through the demonstration battle interface, the process in which the target virtual character performs interaction based on the target interaction attribute. The demonstration battle interface also includes a battle area, and the process in which the target virtual character performs interaction may be demonstrated in the battle area. Correspondingly, as shown in (2) in FIG. 7, after exiting the demonstration for the target virtual character, the terminal switches from displaying the demonstration battle interface to displaying the battle interface, that is, displays the original battle virtual character in the battle interface again. In this way, when a demonstration is performed, the battle interface is switched to the demonstration battle interface, to avoid interference of information in the battle interface to a display effect, and improve a demonstration effect. In this way, a display effect of related information of a target preparation virtual character is better, and display resource utilization and information reachability are improved.

In some embodiments, the terminal may demonstrate, in the following manner, the process in which the target virtual character performs interaction based on the target interaction attribute possessed by the target virtual character: displaying, in response to the demonstration instructions, a demonstration battle area in the battle interface in a floating window form or a picture-in-picture form, and demonstrating, through the demonstration battle area, the process in which the target virtual character performs interaction based on the target interaction attribute.

One demonstration battle area may be displayed in the battle interface, so that the process in which the target virtual character performs interaction based on the target interaction attribute can be demonstrated through the demonstration battle area, and the process in which the target virtual character performs interaction based on the target interaction attribute during a battle can be demonstrated simultaneously. The demonstration battle area may be displayed in the floating window form, or may be displayed in the picture-in-picture form. In this way, the process in which the target virtual character performs interaction based on the target interaction attribute can be demonstrated simultaneously during the battle. When participating the battle, the user can further simultaneously learn the interaction condition of the target virtual character, thereby improving device resource utilization.

In some embodiments, the terminal may display an information panel of the target virtual character, and display, in the information panel, at least one of the following target interaction attributes of the target virtual character: a character attribute, a virtual equipment attribute, a virtual skill attribute, and a virtual bond attribute.

When the process in which the target virtual character performs interaction based on the target interaction attribute is demonstrated, the information panel of the target virtual character may be further displayed. The information panel is configured to display the at least one of the following target interaction attributes of the target virtual character: the character attribute, the virtual equipment attribute, the virtual skill attribute, and the virtual bond attribute. The character attribute is an attribute of the target virtual character, such as a star level, quality, and a character category of the target virtual character. The virtual skill attribute is configured for indicating an attribute (for example, attack force of an attack skill or healing power of a healing skill) of a virtual skill possessed by the target virtual character. The virtual bond attribute is configured for indicating an attribute of a bond possessed by the target virtual character, for example, a battle power bonus value that can be provided for the virtual character by activating the bond. The virtual equipment skill is configured for indicating an attribute (for example, attack force of attack equipment and defense power of defense equipment) of virtual equipment assembled by the target virtual character.

In some embodiments, the terminal may extend or retract the information panel in the following manner: displaying a panel display control of the information panel; and retracting, in response to a trigger operation for the panel display control, the displayed information panel to the panel display control, the panel display control being configured to extend, when the trigger operation for the panel display control is received again, the panel display control to display the information panel.

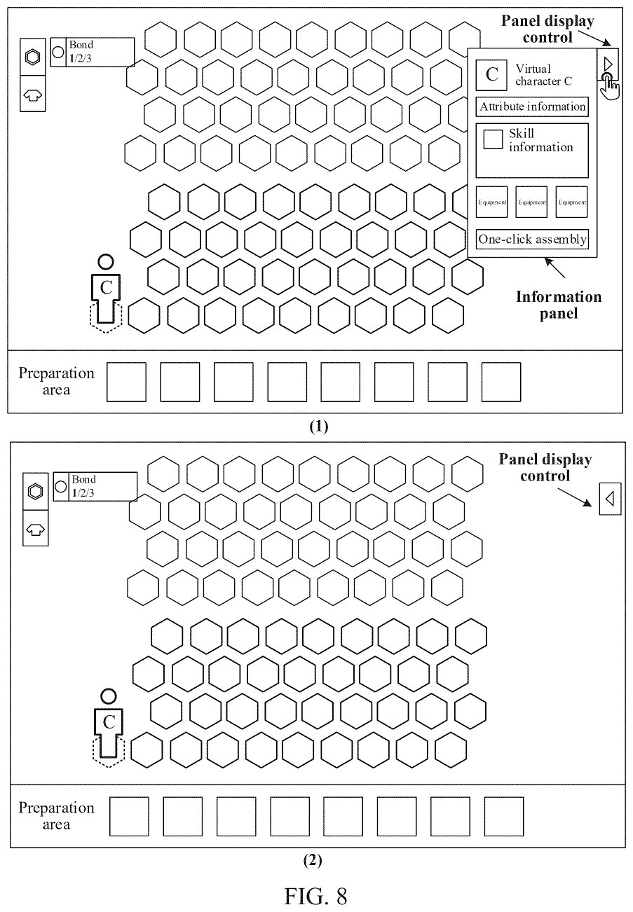

The information panel may be extended or retracted. When the information panel is retracted, demonstration for the target virtual character can be viewed more comprehensively, thereby improving utilization of screen resources. During actual application, referring to FIG. 8, as shown in (1) in FIG. 8, an information panel is displayed in a demonstration battle interface, and a character attribute, a virtual skill attribute, and a virtual equipment attribute of a target virtual character (namely, a virtual character C) are displayed in the information panel. In addition, a panel display control of the information panel is further displayed. When a trigger operation for the panel display control is received, in response to the trigger operation, the displayed information panel is retracted to the panel display control, that is, the information panel is no longer displayed, as shown in (2) in FIG. 8. When the trigger operation for the panel display control is received again, in response to the trigger operation, the panel display control is extended to display the information panel, as still shown in (1) in FIG. 8. In this way, a user may extend or retract the information panel according to requirements, thereby improving information viewing experience of the user and screen resource utilization.

In some embodiments, a terminal may exit demonstration for the target virtual character in the following manner: displaying a demonstration exit control; and exiting, in response to a trigger operation for the demonstration exit control, the demonstration for the target virtual character. The demonstration exit control may be further displayed when a process in which the target virtual character performs interaction based on a target interaction attribute is demonstrated. In this way, the user may trigger, based on the demonstration exit control, demonstration exit instructions for the target virtual character. When the terminal receives the trigger operation for the demonstration exit control, it indicates that the user triggers the demonstration exit instructions for the target virtual character, and in this case, the demonstration for the target virtual character is exited. In this way, the demonstration exit control is provided, so that the user may control start and exit of a demonstration according to requirements, thereby improving user experience. In addition, because the user can control, based on the demonstration exit control, the exit of the demonstration at any time, and an entire interaction process does not need to be demonstrated each time, a waste of device resources is reduced, and device resource utilization is improved.

In some embodiments, the target interaction attribute includes a virtual equipment attribute. The terminal may demonstrate, in response to the demonstration instructions and in the following manner, a process in which the target virtual character performs interaction based on the target interaction attribute possessed by the target virtual character: displaying, in response to the demonstration instructions, a first equipment assembly control of the virtual equipment attribute; and controlling, in response to a trigger operation for the first equipment assembly control, the target virtual character to be assembled with target virtual equipment, and demonstrating a process in which the target virtual character performs interaction based on the target virtual equipment.

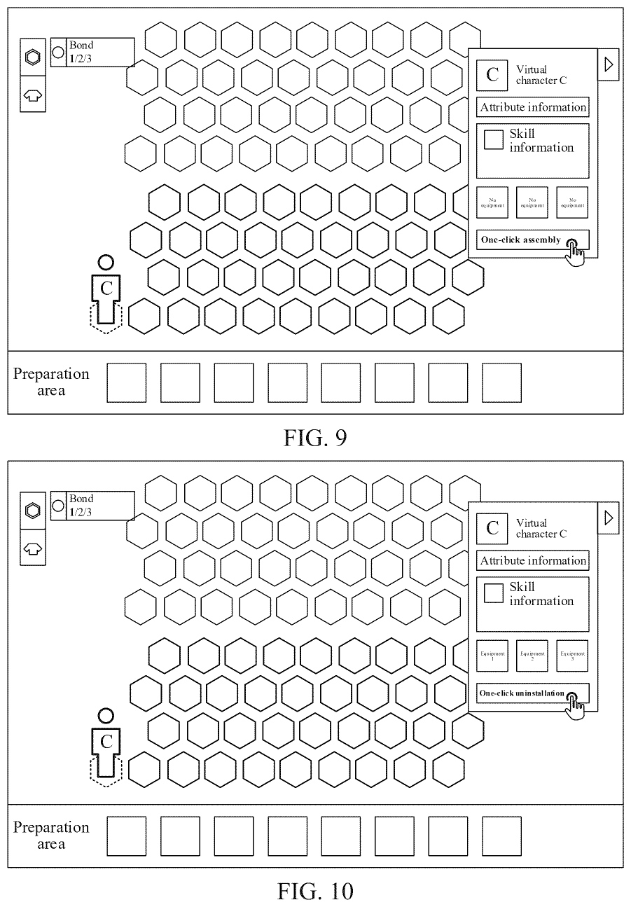

A character attribute and a virtual skill attribute are inherent attributes of the target virtual character and cannot be adjusted by a player. The target virtual character may improve, based on the inherent attributes and through assembling virtual equipment, battle strength of the target virtual character. Therefore, as shown in FIG. 9, a first equipment assembly control (namely, “one-click assembly” in FIG. 9) configured for assembling virtual equipment may be further provided for a user to assemble, based on the first equipment assembly control, the virtual equipment, to demonstrate which virtual equipment is assembled for the target virtual character and an improvement effect of battle strength that can be brought by assembling the virtual equipment. When receiving the trigger operation for the first equipment assembly control, the terminal controls the target virtual character to be assembled with target virtual equipment. The target virtual equipment may be adapted to the target virtual character. The target virtual equipment may be default by a system, or may be determined according to a condition in which the target virtual character is assembled with the virtual equipment in historical interaction. For example, the target virtual equipment is obtained after measurement is performed through a reference quantity. The reference quantity may be the highest win rate, the highest degree of recommendation by players, the highest battle strength, or the like in the historical interaction. In this way, the first equipment assembly control is provided, and a virtual equipment attribute of the target virtual character can be adjusted in a demonstration process, to provide the user with demonstration of a richer interaction process. In this way, layout efficiency in a virtual scene and immersive experience of the user in the virtual scene can be improved. In addition, implementation of the entire process is simple, and man-machine interaction efficiency is high.

In some embodiments, the terminal may control, in the following manner, the target virtual character to be assembled with the target virtual equipment: displaying, in response to the trigger operation for the first equipment assembly control, assembly reference information for the target virtual character; selecting, from a plurality of pieces of candidate virtual equipment and based on the assembly reference information, target candidate virtual equipment adapted to the target virtual character; and assembling the target candidate virtual equipment serving as the target virtual equipment to the target virtual character. The assembly reference information is used to indicate virtual equipment with which the target virtual character is assembled, which is also used as a reference. The assembly reference information may be assembly information that is defaulted by a system and that is for the target virtual character, or may be assembly information obtained after measurement is performed through a reference quantity. The reference quantity may be the highest win rate, the highest degree of recommendation by players, the highest battle strength, or the like in the historical interaction. Based on the assembly reference information, the target candidate virtual equipment adapted to the target virtual character is selected from the plurality of pieces of candidate virtual equipment as the target virtual equipment. In this way, one-click assembly of the virtual equipment is implemented through the first equipment assembly control, which conforms to a scenario in which the player has limited learning time during a battle. Therefore, operation efficiency of the user and device resource utilization are improved.

In addition, after the target virtual character is controlled to be assembled with the target virtual equipment, a process in which the target virtual character performs interaction based on the target virtual equipment may be demonstrated, that is, an improvement effect of battle strength that can be brought during interaction when the target virtual character is assembled with the target virtual equipment may be demonstrated. In the demonstration process, an interaction special effect (for example, feedback of damage caused to an opponent character, and effect performance such as deceleration and daze) of assembling the target virtual equipment for interaction, a value of improved battle strength, feedback of an effect of the target virtual equipment, and the like may be displayed. In this way, the user may intuitively and comprehensively learn an interaction condition (namely, an actual battle effect) when the target virtual character is assembled with the target virtual equipment in a battle.

In some embodiments, a target interaction attribute includes a virtual equipment attribute. The terminal may demonstrate, in response to demonstration instructions and in the following manner, a process in which the target virtual character performs interaction based on the target interaction attribute possessed by the target virtual character: displaying, in response to the demonstration instructions, a second equipment assembly control of the virtual equipment attribute; displaying, in response to a trigger operation for the second equipment assembly control, the plurality of pieces of candidate virtual equipment and a selection control of each candidate virtual equipment; and controlling, in response to a selection operation that is triggered based on the selection control and that is for the target virtual equipment in the plurality of pieces of candidate virtual equipment, the target virtual character to be assembled with the target virtual equipment, and demonstrating the process in which the target virtual character performs interaction based on the target virtual equipment.

In addition to a case in which one-click assembly of equipment may be achieved through the foregoing first equipment assembly control, the second equipment assembly control may be further provided. The user may select, through the second equipment assembly control, to-be-assembled virtual equipment according to requirements. When receiving the trigger operation for the second equipment assembly control, the terminal displays, in response to the trigger operation, the plurality of pieces of candidate virtual equipment and the selection control of each candidate virtual equipment. In this way, the to-be-assembled virtual equipment may be selected based on the selection control. When the selection operation that is triggered based on the selection control and that is for the target virtual equipment in the plurality of pieces of candidate virtual equipment is received, the target virtual character is controlled to be assembled with the target virtual equipment, and the process in which the target virtual character performs interaction based on the target virtual equipment is demonstrated. That is, the improvement effect of the battle strength that can be brought during the interaction when the target virtual character is assembled with the target virtual equipment is demonstrated. In the demonstration process, the interaction special effect (for example, feedback of damage caused to an opponent character, and effect performance such as deceleration and daze) of assembling the target virtual equipment for interaction, the value of the improved battle strength, the feedback of the effect of the target virtual equipment, and the like may be displayed. In this way, the user may intuitively and comprehensively learn the interaction condition (namely, the actual battle effect) when the target virtual character is assembled with the target virtual equipment in the battle.

In some embodiments, after controlling the target virtual character to be assembled with the target virtual equipment, the terminal may further control, in the following manner, the target virtual character to uninstall the target virtual equipment: displaying an equipment uninstallation control; and controlling, in response to a trigger operation for the equipment uninstallation control, the target virtual character to uninstall the target virtual equipment. As shown in FIG. 10, an equipment uninstallation control “one-click uninstallation” may be further provided, and target virtual equipment assembled to a target virtual character can be uninstalled through the equipment uninstallation control. In addition, one-click uninstallation may be implemented only by triggering a trigger operation for the equipment uninstallation control, and the operation is simple. This improves man-machine interaction efficiency when a user learns the target virtual character and conforms to a scenario in which a player has limited learning time during a battle.

In some embodiments, a target interaction attribute includes a virtual bond attribute, and the virtual bond attribute is at a first level. The terminal may demonstrate, in response to demonstration instructions and in the following manner, a process in which the target virtual character performs interaction based on the target interaction attribute possessed by the target virtual character: demonstrating, in response to the demonstration instructions, a process in which the target virtual character performs interaction based on the virtual bond attribute at the first level. A bonus effect of battle strength that can be brought during interaction when the target virtual character performs interaction based on the virtual bond attribute at the first level is demonstrated. In a demonstration process, an interaction special effect (for example, feedback of damage caused to an opponent character, and effect performance such as deceleration and daze) of interaction performed based on the assembled virtual bond attribute at the first level, a value of bonus battle strength, feedback of an effect of the virtual bond attribute at the first level, and the like may be displayed. In this way, the user may intuitively and comprehensively learn an interaction condition (namely, an actual battle effect) when the target virtual character is assembled with the virtual bond attribute at the first level during a battle.

In some embodiments, the target interaction attribute includes the virtual bond attribute, and the virtual bond attribute is at the first level. The terminal may demonstrate, in response to the demonstration instructions and in the following manner, the process in which the target virtual character performs interaction based on the target interaction attribute possessed by the target virtual character: displaying, in response to the demonstration instructions, a level adjustment control of the virtual bond attribute; receiving, based on the level adjustment control, level adjustment instructions for the virtual bond attribute; and adjusting, in response to the level adjustment instructions, the virtual bond attribute from the first level to a second level indicated by the level adjustment instructions, and demonstrating a process in which the target virtual character performs interaction based on the virtual bond attribute at the second level.

The virtual bond attribute includes a plurality of levels. Therefore, the level adjustment control of the virtual bond attribute may be further displayed, and the user may adjust the level of the virtual bond attribute based on the level adjustment control, to demonstrate a process in which the target virtual character performs interaction based on the virtual bond attribute at each level. This helps the user learn the interaction condition (namely, the actual battle effect) during the battle based on the virtual bond attribute at each level, and improve a demonstration effect, thereby facilitating layout of the battle by the user, and improving immersive experience of the user in a virtual scene. In addition, level adjustment may be implemented only through the level adjustment control of the virtual bond attribute, man-machine interaction is simple, and man-machine interaction efficiency is improved.

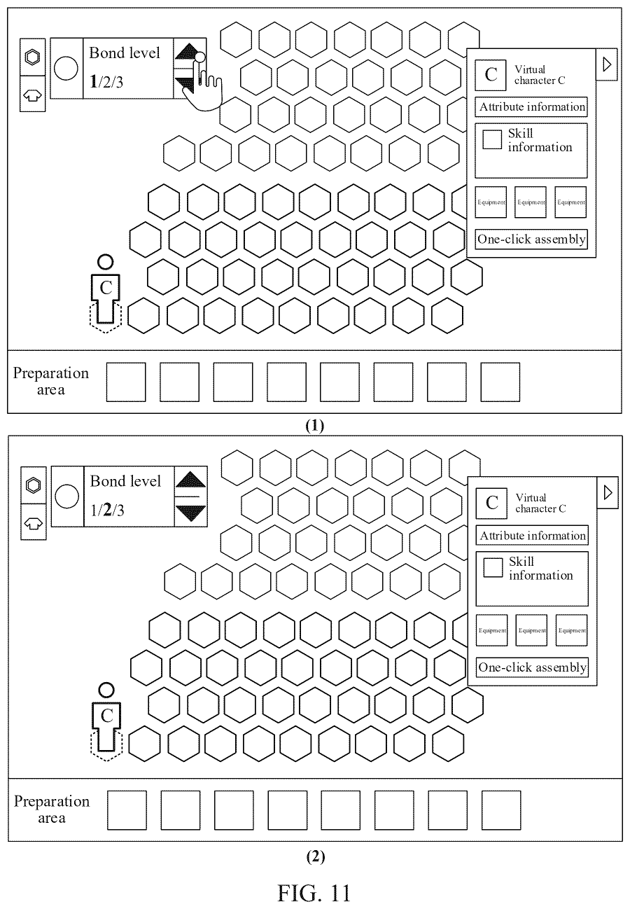

During actual application, the level adjustment control of the virtual bond attribute may be displayed in a demonstration battle interface. As shown in (1) in FIG. 11, the level adjustment control includes a level upgrading control and a level downgrading control. When a terminal receives, based on the level adjustment control, level adjustment instructions (for example, level upgrading instructions triggered based on the level upgrading control or level downgrading instructions triggered based on the level downgrading control) for a bond attribute, the terminal adjusts the virtual bond attribute from a first level to a second level indicated by the level adjustment instructions. As shown in (1) in FIG. 11 to (2) in FIG. 11, a level of the virtual bond attribute is changed from a level “1” to a level “2”.

In the foregoing process of performing interaction based on the virtual bond attribute at each level and the foregoing process of performing interaction based on assembly of target virtual equipment, a process in which the target virtual character releases the virtual bond attribute and uses the target virtual equipment may be demonstrated, or a process in which the virtual bond attribute is released and the target virtual equipment is used when the target virtual character interacts with an opponent virtual character may also be demonstrated.

In some embodiments, the terminal may demonstrate, in the following manner, a process in which the target virtual character performs interaction based on a target interaction attribute: displaying a simulated battle character control; generating, in response to a trigger operation for the simulated battle character control, a simulated battle character; and demonstrating, in response to dragging the simulated battle character to a battle area, a process in which the target virtual character interacts with the simulated battle character based on the target interaction attribute.

One simulated battle character control may be provided, and a simulated battle character that battles with the target virtual character can be generated through the simulated battle character control. During actual application, each time the trigger operation for the simulated battle character control is triggered, one simulated battle character may be generated, so that a plurality of simulated battle characters may be arranged. When the simulated battle character is dragged to the battle area (namely, a battle area of an opponent camp), the target virtual character is controlled to be in a battle state. In this case, the process in which the target virtual character interacts with the simulated battle character based on the target interaction attribute is demonstrated. The target interaction attribute may include the foregoing virtual equipment attribute, virtual bond attribute, virtual skill attribute, and character attribute, to demonstrate an interaction condition (namely, an actual battle effect) when the target virtual character performs interaction based on the target interaction attribute in a battle, that is, to demonstrate an interaction special effect (for example, feedback of damage caused to an opponent character, and effect performance such as deceleration and daze caused by a virtual skill) of interaction performed based on an interaction attribute such as a target virtual equipment attribute, an attribute of a virtual bond at a target level, or a virtual skill attribute, a value of improved battle strength, a bonus condition of battle power that is caused by the virtual bond attribute, feedback of an effect of the target virtual equipment, and the like. In this way, a demonstration effect of the interaction condition can be improved, and can be implemented only through the simulated battle character control. A man-machine interaction operation is simple, and man-machine interaction efficiency is improved.

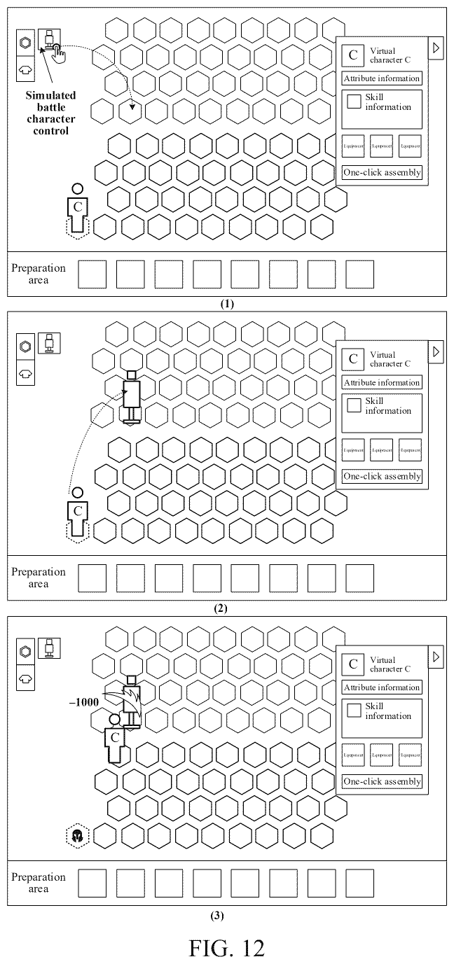

In an example, referring to FIG. 12, as shown in (1) in FIG. 12, a simulated battle character control is displayed in a demonstration battle interface. A simulated battle character is generated in response to a trigger operation for the simulated battle character control. When the simulated battle character is dragged to a battle area of the demonstration battle interface, a process in which a target virtual character interacts with the simulated battle character based on a target interaction attribute is demonstrated. As shown in (2) in FIG. 12 to (3) in FIG. 12, the target virtual character is moved to a location of the simulated battle character for interaction, and an effect of “−1000” is generated for the simulated battle character.

During actual application, a user may further end the interaction with the target virtual character by moving the simulated battle character out of the battle area. In this case, when the simulated battle character does not exist anymore in the battle area, the target virtual character may exit a battle state.

When the foregoing embodiment of this application is applied, in a battle interface configured for virtual characters in a plurality of camps to have a battle in a virtual scene, at least one preparation virtual character preparing to participate in the battle is displayed, and a virtual character demonstration control is displayed. Based on the virtual character demonstration control, demonstration instructions for a target virtual character in the at least one preparation virtual character is received. In response to the demonstration instructions, a process in which the target virtual character performs interaction based on a target interaction attribute possessed by the target virtual character is demonstrated. One virtual character demonstration control is provided in a battle interface, and demonstration instructions for a virtual character can be triggered through the virtual character demonstration control, to demonstrate a process in which the virtual character performs interaction based on a target interaction attribute possessed by the virtual character. In this way, first, the user can learn an interaction attribute of the virtual character and a corresponding interaction condition more comprehensively and intuitively, an information display effect is optimized, and display resource utilization is improved; second, the user can learn an interaction condition of a preparation virtual character in a process in which the virtual character participates in a battle, and a layout effect of a battle lineup is improved; and third, a quantity of times of man-machine interaction operations that are to be performed to achieve an objective (that is, learn the interaction attribute of the virtual character and the corresponding interaction condition) is reduced, and man-machine interaction efficiency and device resource utilization are improved.

The following describes an exemplary application of the embodiments of this application in an actual application scenario by using a virtual chess and card game scene as an example. A core point of interest of a self-propelled chess game is matching between different virtual chess pieces. Each virtual chess piece has its unique skill mechanism and battle mechanism, and a plurality of virtual chess pieces with similar bonds can further activate a strong bond effect. For effects such as attacks, skills, equipment, and bonds of a virtual chess piece in a game, there is a learning threshold for both an old player (for example, a case in which a new virtual chess piece or bond is added, or an attribute of an original virtual chess piece or bond changes) and a new player. In the related art, a player can view a text guide of the virtual chess pieces only by viewing a graphic in a non-battle scene. In this way, a chess piece battle and a skill release effect cannot be viewed during a battle. Only general data descriptions are available. Therefore, a specific effect can be viewed only when the virtual chess pieces are purchased to participate in a battle. There is a risk of trial and error, which may cause a defeat in a battle. In addition, a plurality of virtual chess pieces form a bond, and generally, it is difficult to activate a large quantity of bonds in a battle, and it is difficult to learn the bond effect.

Based on this, in this embodiment of this application, a demonstration chess grid (namely, the foregoing demonstration battle chess grid) is additionally added in a battle area of a virtual chessboard. After the player drags a target virtual chess piece to the demonstration chess grid, the demonstration chess grid is activated. In this case, a demonstration mode is entered, so that when a cognitive habit of the player is conformed, a channel for knowledge and learning of the virtual chess piece is added. In the demonstration mode, various real battle demonstrations of the virtual chess piece including effects such as a skill, an attack, a bond, and equipment may be viewed, and the demonstration mode may be exited when the target virtual chess piece is dragged back to a preparation area. In this way, the player can quickly view and learn information about the virtual chess piece in a battle stage or a preparation stage, to make more accurate layout determining.

### 1. Enter the Demonstration Mode

(1) As shown in (1) in FIG. 6, in a normal battle interface, the demonstration chess grid is in an inactive state, and a display style of the demonstration chess grid is different from a display style of a chess grid in the battle area.

(2) As shown in (2) in FIG. 6, a target virtual chess piece C is dragged to the demonstration chess grid, and the demonstration chess grid is activated. In this case, the demonstration mode is entered and the demonstration battle interface is displayed (virtual chess pieces A and B in the normal battle interface disappear). In the demonstration mode, an information panel of the target virtual chess piece C dragged to the demonstration chess grid may be displayed by default.

### 2. Functions of the Demonstration Battle Interface

(1) Information panel: As shown in FIG. 8, the panel display control may be clicked to retract or extend the information panel. After the information panel is retracted, it is beneficial to more comprehensively view battle information in the demonstration battle interface.
(2) One-click assembly of equipment: As shown in FIG. 9, an assembly control “one-click assembly” can quickly assemble, according to a target virtual chess piece, virtual equipment suitable for the target virtual chess piece, making it convenient for a player to view battle strength of the target virtual chess piece after being assembled with the virtual equipment. Certainly, as shown in FIG. 10, after the virtual equipment is assembled, the assembled virtual equipment may also be quickly uninstalled through an assembly cancellation control “one-click uninstallation”. During actual application, an equipment viewing control for viewing an attribute of the virtual equipment may be further provided. Certainly, considering that learning time of the player is limited in a battle, and more detailed operations cause higher learning costs, the equipment viewing control may not be provided.
(3) Demonstration of a bond effect: As shown in FIG. 11, after the demonstration mode is entered, the level upgrading control configured to upgrade a bond level and the level downgrading control configured to downgrade the bond level may be added to a bond function bar. The player may click a corresponding control to upgrade or downgrade the bond level of a bond. In addition, the demonstration battle interface feeds back a bonus effect of the bond at a corresponding bond level in real time.
(4) Simulated battle chess piece: As shown in FIG. 12, in the demonstration mode, a virtual equipment function bar is replaced with a simulated battle chess piece function bar. The player may drag a simulated battle chess piece to a battle area of an opponent. When there is a simulated battle chess piece on a virtual chessboard, a target virtual chess piece on our side enters a battle state. In this case, the target virtual chess piece automatically starts to battle with the simulated battle chess piece. During the battle, the target virtual chess piece releases attacks and skills, and the player may view, in real time, skill damage feedback and special effect performance such as deceleration and daze brought by the skills, for example, effect performance of “−1000” shown in FIG. 12. As shown in FIG. 12, when the target virtual chess piece on our side is a close battle chess piece, the target virtual chess piece is moved close to the simulated battle chess piece for battling.

A plurality of simulated battle chess pieces may be repeatedly placed, but cannot be placed out of the battle area of the opponent. The simulated battle chess piece may be deleted by dragging the simulated battle chess piece out of the battle area. When there is no simulated battle chess piece on the virtual chessboard, the target virtual chess piece exits the battle state.
(5) Exit the demonstration mode. As shown in FIG. 7, when the target virtual chess piece C is dragged to the preparation area, the demonstration mode may be exited, and a normal battle interface is displayed.

The following describes the virtual character processing method provided in the embodiments of this application from a technology side.
(1) The client detects whether the player has a behavior of dragging the target virtual chess piece to the demonstration chess grid. If yes, the demonstration chess grid is activated to enter the demonstration mode, the normal battle interface is controlled to change to the demonstration battle interface, and the virtual equipment function bar is replaced with the simulated battle chess piece function bar. If not, the normal battle game interface is displayed, and a normal virtual equipment function bar is displayed.
(2) The client detects whether the player uses an assembly control for one-click assembly of virtual equipment. If yes, three pieces of virtual equipment suitable for the target virtual chess piece are randomly selected for assembly. If not, status indication information indicating that the target virtual chess piece is not equipped with the virtual equipment is displayed.
(3) The client detects whether the player places the simulated battle chess piece in the battle area of the opponent. If yes, the target virtual chess piece is activated, to enable the target virtual chess piece to be in the battle state. In this case, the target virtual chess piece automatically starts to battle with the simulated battle chess piece. During the battle, the target virtual chess piece releases attacks and skills. If not, the target virtual chess piece is controlled to be in a preparation state.
(4) The client detects whether the player performs an operation to upgrade or downgrade a bond level. If yes, an effect of a bond at a corresponding level is fed back in real time. If not, an effect of a bond at a current level is maintained.

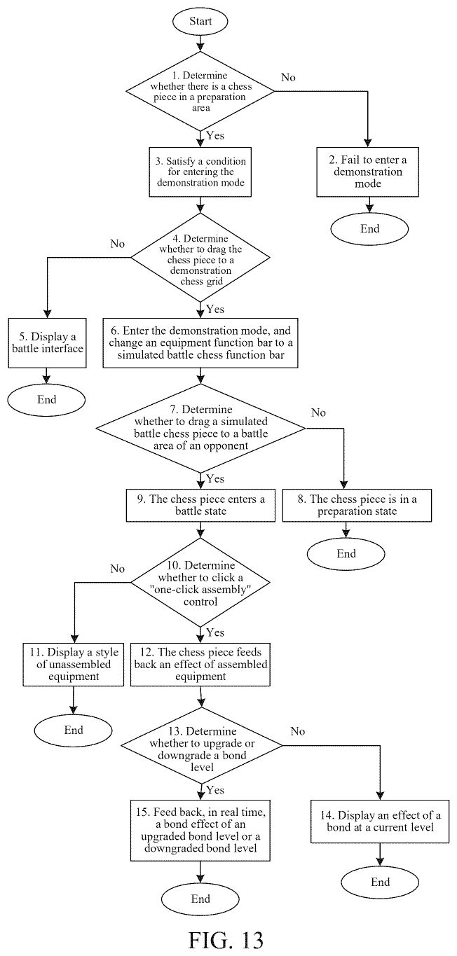

Still, FIG. 13 is a schematic flowchart of a virtual character processing method according to an embodiment of this application. The virtual character processing method provided in this embodiment of this application includes:
1. determining whether there is a chess piece in a preparation area, if not, performing 2, or if yes, performing 3; 2. failing to enter a demonstration mode; 3. satisfying a condition for entering the demonstration mode; 4. determining whether to drag the chess piece to a demonstration chess grid, if not, performing 5, or if yes, performing 6; 5. displaying a battle interface; 6. entering the demonstration mode, and changing an equipment function bar to a simulated battle chess piece function bar; 7. determining whether to drag a simulated battle chess piece to a battle area of an opponent, if not, performing 8, or if yes, performing 9; 8. the chess piece being in a preparation state; 9. the chess piece entering a battle state; 10. determining whether to click a “one-click assembly” control, if not, performing 11, or if yes, performing 12; 11. displaying a style of unassembled equipment; 12. feeding back, by the chess piece, an effect of assembled equipment; 13. determining whether to upgrade or downgrade a bond level, if not, performing 14, or if yes, performing 15; 14. displaying an effect of a bond at a current level; and 15. feeding back, in real time, a bond effect of an upgraded bond level or a downgraded bond level.

When the foregoing embodiment of this application is applied, a method for conveniently viewing various real battle demonstrations of a virtual chess piece including effects such as a skill, an attack, a bond, and equipment is provided, to resolve a problem that a player cannot preview the effects such as an attack, a skill, equipment, and a bond of the virtual chess piece during a battle of a virtual chess and card game. In this way, the player can better use spare time during the battle and quickly and deeply learn a skill mechanism and a battle mechanism of the virtual chess piece, to improve game proficiency and improve a game cognitive level and strategy.

The following continues to describe an exemplary structure in which a virtual character processing apparatus 555 provided in an embodiment of this application is implemented as a software module. In some embodiments, as shown in FIG. 2, the software module in the virtual character processing apparatus 555 stored in the memory 550 may include: a display module 5551, configured to display, in a battle interface configured for virtual characters in a plurality of camps to have a battle in a virtual scene, at least one preparation virtual character preparing to participate in the battle, and display a virtual character demonstration control; a receiving module 5552, configured to receive, based on the virtual character demonstration control, demonstration instructions for a target virtual character in the at least one preparation virtual character; and a demonstration module 5553, configured to demonstrate, in response to the demonstration instructions, a process in which the target virtual character performs interaction based on a target interaction attribute possessed by the target virtual character.

In some embodiments, the battle interface includes a preparation area and a battle area. The display module 5551 is further configured to display, in the preparation area, the at least one preparation virtual character preparing to participate in the battle. The display module 5551 is further configured to display, in the battle area, the virtual character demonstration control.

In some embodiments, the battle interface is a virtual chessboard, and the battle area includes a plurality of battle chess grids. The display module 5551 is further configured to display, in the battle area, a demonstration battle chess grid different from the battle chess grid, the demonstration battle chess grid indicating the virtual character demonstration control. The receiving module 5552 is further configured to: receive a first dragging operation of dragging the target virtual character from the preparation area to the demonstration battle chess grid; and receive, in response to the first dragging operation being released, the demonstration instructions for the target virtual character in the at least one preparation virtual character.

In some embodiments, the receiving module 5552 is further configured to receive a second dragging operation of dragging the target virtual character from the demonstration battle chess grid to the preparation area; and exit, in response to the second dragging operation being released, demonstration for the target virtual character.

In some embodiments, the receiving module 5552 is further configured to: display, in response to a trigger operation for the virtual character demonstration control, a selection control of each preparation virtual character; and receive, in response to a selection operation that is triggered based on the selection control and that is for the target virtual character, the demonstration instructions for the target virtual character in the at least one preparation virtual character.

In some embodiments, the display module 5551 is further configured to display the virtual character demonstration control of each preparation virtual character. The receiving module 5552 is further configured to receive, in response to the trigger operation for a virtual character demonstration control of the target virtual character, the demonstration instructions for the target virtual character in the at least one preparation virtual character.

In some embodiments, the demonstration module 5553 is further configured to: switch, in response to the demonstration instructions, from displaying the battle interface to displaying a demonstration battle interface of the target virtual character, and demonstrate, through the demonstration battle interface, the process in which the target virtual character performs interaction based on the target interaction attribute; or display, in response to the demonstration instructions, a demonstration battle area in the battle interface in a floating window form or a picture-in-picture form, and demonstrate, through the demonstration battle area, the process in which the target virtual character performs interaction based on the target interaction attribute.

In some embodiments, the demonstration module 5553 is further configured to: display an information panel of the target virtual character; and display, in the information panel, at least one of the following target interaction attributes of the target virtual character: a character attribute, a virtual equipment attribute, a virtual skill attribute, and a virtual bond attribute.

In some embodiments, the demonstration module 5553 is further configured to: display a panel display control of the information panel; and retract, in response to a trigger operation for the panel display control, the displayed information panel to the panel display control, the panel display control being configured to extend, when the trigger operation for the panel display control is received again, the panel display control to display the information panel.

In some embodiments, the target interaction attribute includes a virtual equipment attribute. The demonstration module 5553 is further configured to: display, in response to the demonstration instructions, a first equipment assembly control of the virtual equipment attribute; and control, in response to a trigger operation for the first equipment assembly control, the target virtual character to be assembled with target virtual equipment, and demonstrate a process in which the target virtual character performs interaction based on the target virtual equipment.

In some embodiments, the demonstration module 5553 is further configured to: obtain, in response to a trigger operation for the first equipment assembly control, assembly reference information for the target virtual character; select, from a plurality of pieces of candidate virtual equipment and based on the assembly reference information, target candidate virtual equipment adapted to the target virtual character; and assemble the target candidate virtual equipment serving as the target virtual equipment to the target virtual character.

In some embodiments, the target interaction attribute includes the virtual equipment attribute. The demonstration module 5553 is further configured to: display, in response to the demonstration instructions, a second equipment assembly control of the virtual equipment attribute; display, in response to a trigger operation for the second equipment assembly control, the plurality of pieces of candidate virtual equipment and a selection control of each candidate virtual equipment; and control, in response to a selection operation that is triggered based on the selection control and that is for target virtual equipment in the plurality of pieces of candidate virtual equipment, the target virtual character to be assembled with the target virtual equipment, and demonstrate the process in which the target virtual character performs interaction based on the target virtual equipment.

In some embodiments, the demonstration module 5553 is further configured to: display an equipment uninstallation control; and control, in response to a trigger operation for the equipment uninstallation control, the target virtual character to uninstall the target virtual equipment.

In some embodiments, the target interaction attribute includes a virtual bond attribute, the virtual bond attribute is at a first level. The demonstration module 5553 is further configured to: display, in response to the demonstration instructions, a level adjustment control of the virtual bond attribute; receive, based on the level adjustment control, level adjustment instructions for the virtual bond attribute; and adjust, in response to the level adjustment instructions, the virtual bond attribute from the first level to a second level indicated by the level adjustment instructions, and demonstrate a process in which the target virtual character performs interaction based on the virtual bond attribute at the second level.

In some embodiments, the demonstration module 5553 is further configured to: display, in response to the demonstration instructions, a simulated battle character control; generate, in response to a trigger operation for the simulated battle character control, a simulated battle character; and demonstrate, in response to dragging the simulated battle character to the battle area of the demonstration battle interface, a process in which the target virtual character interacts with the simulated battle character based on the target interaction attribute.

In some embodiments, the demonstration module 5553 is further configured to: display a demonstration exit control; and exit, in response to a trigger operation for the demonstration exit control, the demonstration for the target virtual character.

When the foregoing embodiment of this application is applied, in a battle interface configured for virtual characters in a plurality of camps to have a battle in a virtual scene, at least one preparation virtual character preparing to participate in the battle is displayed, and a virtual character demonstration control is displayed. Based on the virtual character demonstration control, demonstration instructions for a target virtual character in the at least one preparation virtual character is received. In response to the demonstration instructions, a process in which the target virtual character performs interaction based on a target interaction attribute possessed by the target virtual character is demonstrated. One virtual character demonstration control is provided in the battle interface, and demonstration instructions for a virtual character can be triggered through the virtual character demonstration control, to demonstrate a process in which the virtual character performs interaction based on a target interaction attribute possessed by the virtual character. In this way, first, the user can learn an interaction attribute of the virtual character and a corresponding interaction condition more comprehensively and intuitively, an information display effect is optimized, and display resource utilization is improved; second, the user can learn an interaction condition of a preparation virtual character in a process in which the virtual character participates in a battle, and a layout effect of a battle lineup is improved; and third, a quantity of times of man-machine interaction operations that are to be performed to achieve an objective (that is, learn the interaction attribute of the virtual character and the corresponding interaction condition) is reduced, and man-machine interaction efficiency and device resource utilization are improved.

An embodiment of this application further provides a computer program product. The computer program product includes computer-executable instructions or a computer program, the computer-executable instructions or the computer program being stored in a computer-readable storage medium. A processor of an electronic device reads the computer-executable instructions or the computer program from the computer-readable storage medium, and the processor executes the computer-executable instructions or the computer program, to enable the electronic device to perform the virtual character processing method provided in the embodiments of this application.

An embodiment of this application further provides a non-transitory computer-readable storage medium, having computer-executable instructions or a computer program stored therein, the computer-executable instructions or the computer program, when executed by a processor, enabling the processor to perform the virtual character processing method provided in the embodiments of this application.

In some embodiments, the computer-readable storage medium may be a memory such as a random access memory (RAM), a read-only memory (ROM), a flash memory, a magnetic surface memory, an optical disc, or a compact disc read-only memory (CD-ROM). Alternatively, the computer-readable storage medium may be various devices including one or any combination of the foregoing memories.

In some embodiments, the computer-executable instructions may be written in a form of a program, software, a software module, a script, or code in any form of programming language (including a compilation or interpretation language, or a declarative or procedural language), and may be deployed in any form, including being deployed as an independent program or being deployed as a module, a component, a subroutine, or another unit suitable for use in a computing environment.

In an example, the computer-executable instructions may, but do not necessarily, correspond to a file in a file system, and may be stored in a part of a file having another program or other data stored therein, for example, stored in one or more scripts in a HyperText Markup Language (HTML) document, stored in a single file that is specially used for a program in discussion, or stored in a plurality of collaborative files (for example, files having one or more modules, subprograms, or code parts stored therein).

In an example, the computer-executable instructions may be deployed to be executed on one electronic device, on a plurality of electronic devices located at one location, or on a plurality of electronic devices distributed at a plurality of locations and interconnected by using a communication network.

The foregoing descriptions are merely embodiments of this application and are not intended to limit the protection scope of this application. Any modification, equivalent replacement, or improvement made within the spirit and scope of this application fall within the protection scope of this application.

What is claimed is:

1. A virtual character processing method performed by an electronic device, the method comprising:
displaying, in a battle interface, at least one preparation virtual character preparing to participate in a battle and a virtual character demonstration control associated with the at least one preparation virtual character;
receiving, based on a user instruction via the virtual character demonstration control, demonstration instructions for a target virtual character in the at least one preparation virtual character; and
demonstrating, in response to the demonstration instructions, a process in which the target virtual character performs interaction based on a target interaction attribute possessed by the target virtual character.

2. The method according to claim 1, wherein the battle interface comprises a preparation area and a battle area; and the displaying at least one preparation virtual character preparing to participate in the battle and the virtual character demonstration control comprises:
displaying, in the preparation area, the at least one preparation virtual character preparing to participate in the battle; and
displaying, in the battle area, the virtual character demonstration control.

3. The method according to claim 2, wherein the battle interface is a virtual chessboard, and the battle area comprises a plurality of battle chess grids; the displaying, in the battle area, the virtual character demonstration control comprises:
displaying, in the battle area, a demonstration battle chess grid different from the battle chess grid, the demonstration battle chess grid indicating the virtual character demonstration control; and
the receiving, based on the user instruction via the virtual character demonstration control, demonstration instructions for the target virtual character in the at least one preparation virtual character comprises:
receiving a first dragging operation of dragging the target virtual character from the preparation area to the demonstration battle chess grid; and
receiving, in response to the first dragging operation being released, the demonstration instructions for the target virtual character in the at least one preparation virtual character.

4. The method according to claim 3, further comprising:
receiving a second dragging operation of dragging the target virtual character from the demonstration battle chess grid to the preparation area; and
exiting, in response to the second dragging operation being released, the demonstration for the target virtual character.

5. The method according to claim 1, wherein the receiving, based on the user instruction via the virtual character demonstration control, demonstration instructions for the target virtual character in the at least one preparation virtual character comprises:
displaying, in response to a trigger operation for the virtual character demonstration control, a selection control of each preparation virtual character; and
receiving, in response to a selection operation that is triggered based on the selection control and that is for the target virtual character, the demonstration instructions for the target virtual character in the at least one preparation virtual character.

6. The method according to claim 1, wherein the displaying a virtual character demonstration control comprises:
displaying a virtual character demonstration control of each preparation virtual character; and
the receiving, based on the user instruction via the virtual character demonstration control, demonstration instructions for the target virtual character in the at least one preparation virtual character comprises:
receiving, in response to a trigger operation for a virtual character demonstration control of the target virtual character, the demonstration instructions for the target virtual character in the at least one preparation virtual character.

7. The method according to claim 1, wherein the demonstrating, in response to the demonstration instructions, a process in which the target virtual character performs interaction based on a target interaction attribute possessed by the target virtual character comprises:
switching, in response to the demonstration instructions, from displaying the battle interface to displaying a demonstration battle interface of the target virtual character, and demonstrating, through the demonstration battle interface, the process in which the target virtual character performs interaction based on the target interaction attribute; or
displaying, in response to the demonstration instructions, a demonstration battle area in the battle interface in a floating window form or a picture-in-picture form, and demonstrating, through the demonstration battle area, the process in which the target virtual character performs interaction based on the target interaction attribute.

8. The method according to claim 1, wherein the target interaction attribute comprises a virtual equipment attribute, and the demonstrating, in response to the demonstration instructions, a process in which the target virtual character performs interaction based on a target interaction attribute possessed by the target virtual character comprises:
displaying, in response to the demonstration instructions, a first equipment assembly control of the virtual equipment attribute; and
controlling, in response to a trigger operation for the first equipment assembly control, the target virtual character to be assembled with target virtual equipment, and demonstrating a process in which the target virtual character performs interaction based on the target virtual equipment.

9. The method according to claim 8, wherein the controlling, in response to a trigger operation for the first equipment assembly control, the target virtual character to be assembled with target virtual equipment comprises:
displaying, in response to the trigger operation for the first equipment assembly control, assembly reference information for the target virtual character;
selecting, from a plurality of pieces of candidate virtual equipment and based on the assembly reference information, target candidate virtual equipment adapted to the target virtual character; and
assembling the target candidate virtual equipment serving as the target virtual equipment to the target virtual character.

10. The method according to claim 1, wherein the target interaction attribute comprises the virtual equipment attribute, and the demonstrating, in response to the demonstration instructions, a process in which the target virtual character performs interaction based on a target interaction attribute possessed by the target virtual character comprises:
displaying, in response to the demonstration instructions, a second equipment assembly control of the virtual equipment attribute;
displaying, in response to a trigger operation for the second equipment assembly control, a plurality of pieces of candidate virtual equipment and a selection control of each candidate virtual equipment; and
controlling, in response to a selection operation that is triggered based on the selection control and that is for target virtual equipment in the plurality of pieces of candidate virtual equipment, the target virtual character to be assembled with the target virtual equipment, and demonstrating a process in which the target virtual character performs interaction based on the target virtual equipment.

11. The method according to claim 1, wherein the target interaction attribute comprises a virtual bond attribute, the virtual bond attribute is at a first level, and the demonstrating, in response to the demonstration instructions, a process in which the target virtual character performs interaction based on a target interaction attribute possessed by the target virtual character comprises:
displaying, in response to the demonstration instructions, a level adjustment control of the virtual bond attribute;
receiving, based on the level adjustment control, level adjustment instructions for the virtual bond attribute; and
adjusting, in response to the level adjustment instructions, the virtual bond attribute from the first level to a second level indicated by the level adjustment instructions, and demonstrating a process in which the target virtual character performs interaction based on the virtual bond attribute at the second level.

12. The method according to claim 1, wherein the demonstrating, in response to the demonstration instructions, a process in which the target virtual character performs interaction based on a target interaction attribute possessed by the target virtual character comprises:
displaying, in response to the demonstration instructions, a simulated battle character control;
generating, in response to a trigger operation for the simulated battle character control, a simulated battle character; and
demonstrating, in response to dragging the simulated battle character to the battle area, a process in which the target virtual character interacts with the simulated battle character based on the target interaction attribute.

13. The method according to claim 1, further comprising:
displaying an information panel of the target virtual character; and
displaying, in the information panel, at least one of the following target interaction attributes of the target virtual character: a character attribute, the virtual equipment attribute, a virtual skill attribute, and the virtual bond attribute.

14. The method according to claim 1, further comprising:
displaying a demonstration exit control; and
exiting, in response to a trigger operation for the demonstration exit control, the demonstration for the target virtual character.

15. An electronic device, comprising:
a memory, configured to store computer-executable instructions; and
a processor, configured to implement, when executing the computer-executable instructions stored in the memory, a virtual character processing method including:
displaying, in a battle interface, at least one preparation virtual character preparing to participate in a battle and a virtual character demonstration control associated with the at least one preparation virtual character;
receiving, based on a user instruction via the virtual character demonstration control, demonstration instructions for a target virtual character in the at least one preparation virtual character; and
demonstrating, in response to the demonstration instructions, a process in which the target virtual character performs interaction based on a target interaction attribute possessed by the target virtual character.

16. The electronic device according to claim 15, wherein the battle interface comprises a preparation area and a battle area; and the displaying at least one preparation virtual character preparing to participate in the battle and the virtual character demonstration control comprises:
displaying, in the preparation area, the at least one preparation virtual character preparing to participate in the battle; and
displaying, in the battle area, the virtual character demonstration control.

17. The electronic device according to claim 16, wherein the battle interface is a virtual chessboard, and the battle area comprises a plurality of battle chess grids; the displaying, in the battle area, the virtual character demonstration control comprises:
displaying, in the battle area, a demonstration battle chess grid different from the battle chess grid, the demonstration battle chess grid indicating the virtual character demonstration control; and
the receiving, based on the user instruction via the virtual character demonstration control, demonstration instructions for the target virtual character in the at least one preparation virtual character comprises:
receiving a first dragging operation of dragging the target virtual character from the preparation area to the demonstration battle chess grid; and
receiving, in response to the first dragging operation being released, the demonstration instructions for the target virtual character in the at least one preparation virtual character.

18. The electronic device according to claim 17, wherein the method further comprises:
receiving a second dragging operation of dragging the target virtual character from the demonstration battle chess grid to the preparation area; and
exiting, in response to the second dragging operation being released, the demonstration for the target virtual character.

19. The electronic device according to claim 15, wherein the target interaction attribute comprises a virtual equipment attribute, and the demonstrating, in response to the demonstration instructions, a process in which the target virtual character performs interaction based on a target interaction attribute possessed by the target virtual character comprises:
displaying, in response to the demonstration instructions, a first equipment assembly control of the virtual equipment attribute; and
controlling, in response to a trigger operation for the first equipment assembly control, the target virtual character to be assembled with target virtual equipment, and demonstrating a process in which the target virtual character performs interaction based on the target virtual equipment.

20. A non-transitory computer-readable storage medium, having computer-executable instructions stored therein, the computer-executable instructions, when executed by a processor of an electronic device, causing the electronic device to implement a virtual character processing method including:
displaying, in a battle interface, at least one preparation virtual character preparing to participate in a battle and a virtual character demonstration control associated with the at least one preparation virtual character;
receiving, based on a user instruction via the virtual character demonstration control, demonstration instructions for a target virtual character in the at least one preparation virtual character; and
demonstrating, in response to the demonstration instructions, a process in which the target virtual character performs interaction based on a target interaction attribute possessed by the target virtual character.
